(19) United States
(12) Patent Application Publication
(10) Pub. No.: US 2011/0077115 A1
(43) Pub. Date: Mar. 31, 2011

(54) SYSTEM AND METHOD FOR BELT TENSIONING

(76) Inventor: Morgan H. Dunn, Dallas, TX (US)

(21) Appl. No.: 12/892,982

(22) Filed: Sep. 29, 2010

Related U.S. Application Data
(60) Provisional application No. 61/246,719, filed on Sep. 29, 2009.
(60) Provisional application No. 61/246,724, filed on Sep. 29, 2009.

(51) Int. Cl. F16H 7/08

(52) U.S. Cl. 474/138

(57) ABSTRACT

A system, method, and apparatus for tensioning a belt. An apparatus includes a fixed roller, rotatably coupled to a structure; a tensioning roller, rotatably coupled to a bracket; a biasing device coupled to the structure and to the bracket. The bracket and the tensioning roller are coupled to the structure only by the biasing device and a belt passing around at least a part of the fixed roller and at least a part of the tensioning roller.

### CROSS-REFERENCE TO OTHER APPLICATION

This application claims the benefit of the filing date of U.S. Provisional Patent Application 61/246,719, filed Sep. 29, 2009, and U.S. Provisional Patent Application 61/246,724, filed Sep. 29, 2009, both of which are hereby incorporated by reference.

### TECHNICAL FIELD

The present disclosure is directed, in general, to tensioning of belts in machinery.

### BACKGROUND OF THE DISCLOSURE

In moving belt systems it is important that belt tension be maintained in a desired range. If belt tension is too low, the belt may slip over pulleys. If belt tension is too high, excessive stress may be placed on pulleys, bearing and the belt.

### SUMMARY OF THE DISCLOSURE

Various disclosed embodiments include a system and method for tensioning a belt. An apparatus includes a fixed roller, rotatably coupled to a structure; a tensioning roller, rotatably coupled to a bracket; and a biasing device coupled to the structure and to the bracket. The bracket and the tensioning roller are coupled to the structure only by the biasing device and a belt passing around at least a part of the fixed roller and at least a part of the tensioning roller.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a top view of a belt tensioning system according to a first embodiment;

FIG. 2 depicts a cutaway view of the belt tensioning system of FIG. 1;

FIG. 3 depicts a top view of a belt tensioning system according to a second embodiment;

FIG. 4 depicts a cutaway view of the belt tensioning system of FIG. 3;

FIG. 5 depicts a top view of a belt tensioning system according to a third embodiment;

FIG. 6 depicts a cutaway view of the belt tensioning system of FIG. 5; and

FIG. 7 depicts a top view of a conveyor belt system according to another embodiment.

### DETAILED DESCRIPTION

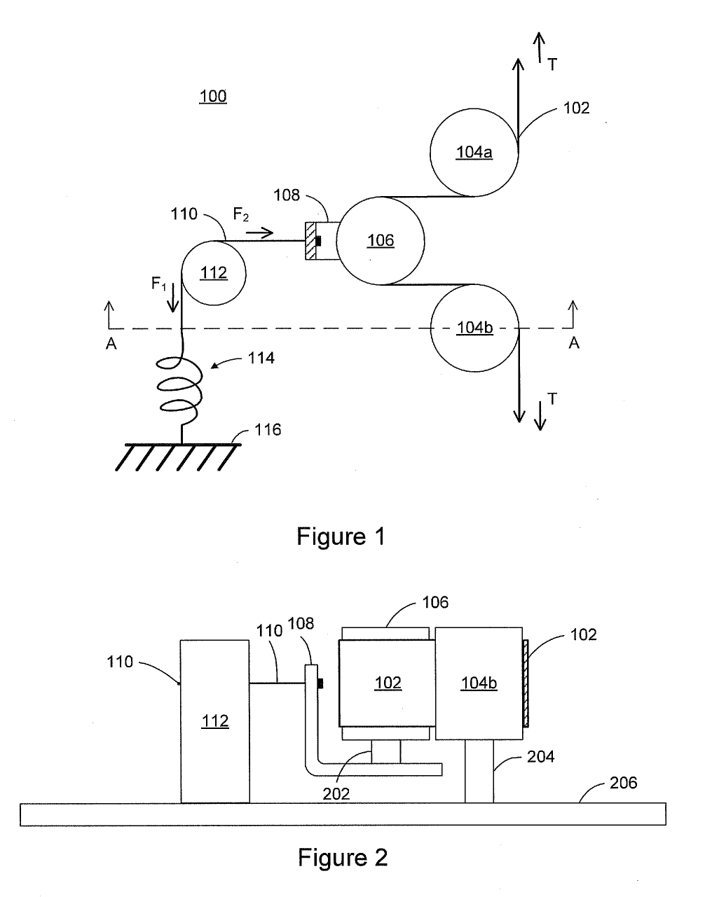

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In a mechanical system that employs a belt—such as a conveyor belt or a power drive belt—belt tension is maintained within a desired range of value to ensure that the mechanical system does not malfunction. For example, if the belt tension drops too low, the belt may slip over a drive pulley, resulting in erratic motion of the belt. If the belt tension rises too high, the belt may place excessive forces on pulleys or rollers in the mechanism, causing the pulleys to bind and stop rolling.

Various methods and systems have been developed with the intention of applying a desired range of tensions to a belt. A tensioning roller may be mounted for motion relative to fixed rollers in the system and biased by a force away from the fixed rollers in order to tension a belt that passes over both the tensioning and fixed rollers. A tensioning roller may be positioned in a straight segment of the belt path and biased by a force in a direction orthogonal to the belt path in order to tension the belt. Typically, such a biasing force is supplied by a spring or a suspended dead weight and operates directly on the tensioning roller or an arm or plate to which the roller mounts. Such a tensioning roller is typically mounted to a base plate of the belt system by an arm, linear bearing, or other mechanism that supplies the biasing force and constrains motion of the tensioning roller. Such tensioning mechanisms may be complex, expensive, bulky, or affected by dynamic forces of the moving belt.

FIG. 1 depicts a top view of a belt tensioning system 100 according to a first embodiment of the disclosure. A belt 102 passes over fixed rollers 104a and 104b and around a floating tensioning roller 106. The tensioning roller 106 is typically positioned just before a belt drive roller in the path of the belt 102—for example, fixed roller 104a or 104b, depending upon the direction of travel of the belt 102. The belt 102 extends from the tensioning system 100 into the rest of a larger mechanical system and may be travelling in either direction through the system.

The floating roller 106 is rotatably mounted to a bracket 108, which is used to move the roller 106 to control the tension of the belt 102. As shown in FIG. 1, motion of the roller 106 in a leftward direction increases the tension of the belt 102 and motion in the rightward direction decreases the tension in the belt 102. The bracket 108 is mechanically coupled to one end of a tensioning cable 110, which passes over a portion of the surface of a fixed capstan 112 and is coupled at its other end to one end of a biasing device 114. The other end of the biasing device 114 is coupled to a fixed location 116. The biasing device 114 may be an extension spring, a constant force spring, a torsion spring, a suspended dead weight, or other suitable mechanism for applying a force to the tensioning cable 110.

The biasing device 114 applies a force F₁ to the tensioning cable 110, which operates to increase the tension in the belt 102. The bracket 108, acting under the tension of the belt 102, applies an opposing force F₂ to the cable 110. When the force F₁ exceeds the force F₂ by an amount sufficient to overcome the capstan effect arising from the friction of the tensioning cable 110 passing around the fixed capstan 112, the tensioning cable 110 moves the bracket 108 and tensioning roller 106 in a direction to increase the tension in the belt 102 (to the left in FIG. 1). Conversely, when the force F₂ exceeds the force F₁ by an amount sufficient to overcome the capstan effect, the tensioning cable 110 moves the bracket 108 and tensioning roller 106 in a direction to decrease the tension in the belt 102 (to the right in FIG. 1).

FIG. 2 depicts a cutaway view of the belt tensioning system 100 along the line AA of FIG. 1. The capstan 112 is fixedly mounted to a base plate 206 or other structure. The tensioning roller 106 is rotatably mounted to the bracket 108 by an axle 202. The fixed roller 104b is rotatably mounted to the base plate 206 by an axle 204. Because the bracket 108 is free to move relative to the base plate 206, the tensioning roller 106 is also free to move relative to the base plate 206, thereby increasing or decreasing tension on the belt 102.

The bracket 108 and the tensioning roller 106 are coupled to the base plate 206 only by the cable 110 and the belt 102. Where the rollers 102, 104a and 104b are crowned rollers, the belt 102 is constrained from moving in the vertical direction in FIG. 2 and the belt 102 acts as a web element of the structure 100 to support the roller 106 and the bracket 108.

The capstan effect of the tensioning cable 110 passing around the capstan 112 may be expressed as:

F_{high}=F_{low}*e^{μΦ},

where e is the mathematical constant referred to as Euler's number, μ is the coefficient of friction between the tensioning cable 110 and the capstan 112, Φ is the number of turns of the tensioning cable 110 around the capstan 112 in radians, F_{high} is the larger of F₁ and F₂, and F_{low} is the smaller of F₁ and F₂. Where both the tensioning cable 110 and the capstan 112 are steel (as in the belt tensioning system 100), the value of μ is 0.8. Where the tensioning cable 110 wraps one-quarter turn around the capstan 112 (as in the belt tensioning system 100), the value of Φ is approximately 1.57. Thus for the tensioning cable 110 and the capstan 112 of the belt tensioning system 100, the value of e^{μΦ} is approximately 3.5 and F_{high}=F_{low}*3.5. That is, if F_{high} exceeds F_{low}, by a factor of 3.5, the tensioning cable 110 will move around the capstan 112 in the direction of F_{high}. However, if F_{high} does not exceed F_{low} by at least a factor of 3.5, the tensioning cable 110 will not move around the capstan 112.

The tension of the belt 102 is depicted by the arrows labeled T in FIG. 1. The belt applies the force T to both sides of the tensioning roller 106, resulting in a force 2*T on the cable 110. The belt tension T is typically in a range from T_{low} to Tₙₒₘᵢₙₐₗ. T_{low} typically occurs at startup, because of the position of the tensioning roller 106 in the path of the belt 102. The value of T_{low} is typically established empirically. Tₙₒₘᵢₙₐₜₑ is the nominal operating tension of the belt 102. The value of Tₙₒₘᵢₙₐₗ is set by the designer of the system in which the belt 102 is used. Factors in the determination of Tₙₒₘᵢₙₐₗ may include belt loading on roller bearings, limits on belt sag between rollers in load-bearing portions of a belt system, minimum drive belt tension required to transfer torque from a drive roller to a system being driven by the belt, and other factors.

In the belt tensioning system 100, a nominal value for the spring force, F₁, is calculated as:

F₁=2*Tₙₒₘᵢₙₐₗ*e^{μΦ}−c,

where Tₙₒₘᵢₙₐₗ and e^{μΦ} are as described above and c is derived empirically to ensure that the belt 102 is not over-tensioned when T approaches T_{low}.

In operation, when the belt 102 is powered off and T approaches the value T_{low}, F₂ may fall below F₁ by more than the capstan effect factor, e^{μΦ}, with the result that the tensioning cable 110 slips in the direction of F₁. This slippage increases F₂ until F₂, aided by the capstan effect, is able to resist further slippage. In this way, the belt tensioning system 100 operates to prevent T from dropping below a specified minimum level. Subsequently, when the belt 102 is powered up and T rises from T_{low} to the value Tₙₒₘᵢₙₐₗ, the tensioning cable 110 does not slip unless F₂ exceeds F₁ by the capstan effect factor: i.e., unless T reaches 3.5*Tₙₒₘᵢₙₐₗ. Such a high belt tension is not likely to occur in normal operation of a system where the belt tensioning system 100 is used.

Thus, the tensioning cable 110 may initially slip around the capstan 112 to adapt to a belt tension near T_{low}. In this way, the belt tensioning system 100 establishes a minimum belt tension in the belt 102. However, once this initial adaptation has occurred, as the tension in the belt 102 rises, the belt tensioning system 100 remains rigid under the expected dynamic tension loads of the belt 102—that is, as long as the tension T remains within the expected range of T_{low} to Tₙₒₘᵢₙₐₗ. The belt tensioning system 100 has a flexible geometry that may be readily adapted to fir around other components of the belt-driven system. Furthermore, the belt tensioning system 100 has a smaller footprint, lower cost, and lower maintenance requirements than many other belt tensioning systems. The tensioning roller 106 is mounted to the floating bracket 108, rather than being mounted by a more complex and more expensive articulated mechanism to the base plate 206, as in some other belt tensioning mechanisms.

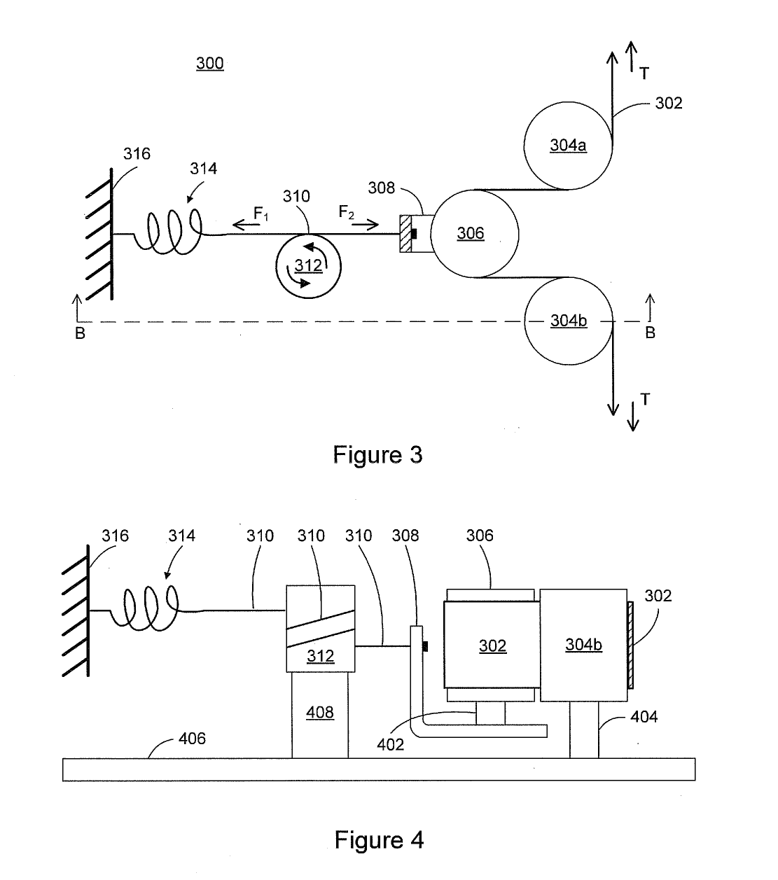

FIG. 3 depicts a top view of a belt tensioning system 300 according to a second embodiment. Like the belt tensioning system 100, the belt tensioning system 300 utilizes the capstan effect of a cable wrapped around a capstan to remain rigid under the expected dynamic tensioning loads of the belt being tensioned. However, the belt tensioning system 300 provides initial system adjustment to low belt tension in a different way than the belt tensioning system 100.

Similar to the belt tensioning system 100, in the belt tensioning system 300 a belt 302 passes over fixed rollers 304a and 304b and around a floating tensioning roller 306. The tensioning roller 306 is typically positioned just before a belt drive roller in the path of the belt 302—for example, fixed roller 304a or 304b, depending upon the direction of travel of the belt 302. The belt 302 extends from the tensioning system 300 into the rest of a larger mechanical system and may be travelling in either direction through the system.

The floating roller 306 is rotatably mounted to a bracket 308, which is used to move the roller 306 to control the tension of the belt 302. As shown in FIG. 3, motion of the roller 306 in a leftward direction increases the tension of the belt 302 and motion in the rightward direction decreases the tension in the belt 302. The bracket 308 is mechanically coupled to one end of a tensioning cable 310, which wraps twice around the surface of a one-way clutch roller 312 and is coupled at its other end to one end of a biasing device 314. The other end of the biasing device 314 is coupled to a fixed location 316. The biasing device 314 may be an extension spring, a constant force spring, a torsion spring, a suspended dead weight, or other suitable mechanism for applying a force to the cable 310.

Unlike the capstan 112 of the belt tensioning system 100, the one-way clutch roller 312 operates as a roller when the tensioning cable 310 is moving in the direction indicated by the arrow labeled F₁ in FIG. 3—that is, in the counter-clockwise direction shown by the arrows on the roller 312. However, because of the action of its one-way clutch mechanism, the roller 312 acts as a capstan to resist motion of the tensioning cable 310 in the direction indicated by the arrow labeled F₂.

The biasing device 314 applies a force F₁ to the tensioning cable 310, which operates to increase the tension in the belt 302. The bracket 308, acting under the tension of the belt 302, applies an opposing force F₂ to the tensioning cable 310. When the force F₁ exceeds the force F₂, the one-way clutch roller 312 rotates in the counter-clockwise direction, allowing the tensioning cable 310 to move the bracket 308 and tensioning roller 306 in a direction to increase the tension in the belt 302 (to the left in FIG. 3).

However, because the roller 312 does not rotate in the clockwise direction, the roller acts as a capstan to resist motion of the tensioning cable 310 in the direction of F₂. Thus, the force F₂ must exceed the force F₁ by an amount sufficient to overcome the capstan effect, in order for the tensioning cable 310, the bracket 308, and the tensioning roller 306 to move in the direction of F₂, decreasing the tension in the belt 302.

FIG. 4 depicts a cutaway view of the belt tensioning system 300 along the line BB of FIG. 3. The one-way clutch roller 312 is mounted to a base plate 406 by a stanchion 408. The tensioning roller 306 is rotatably mounted to the bracket 308 by an axle 402. The fixed roller 304b is rotatably mounted to the base plate 406 by an axle 404. Because the bracket 308 is free to move relative to the base plate 406, the tensioning roller 306 is also free to move relative to the base plate 406, thereby increasing or decreasing tension on the belt 302.

The bracket 308 and the tensioning roller 306 are coupled to the base plate 406 only by the cable 310 and the belt 302. Where the rollers 302, 304a and 304b are crowned rollers, the belt 302 is constrained from moving in the vertical direction in FIG. 4 and the belt 302 acts as a web element of the structure 300 to support the roller 306 and the bracket 308.

As described for the capstan 112, the capstan effect of the tensioning cable 310 passing around the one-way clutch roller 312 may be expressed as F_{high}=F_{low}*e^{μΦ}. Because the roller 312 rotates in the counter-clockwise direction, the capstan effect only applies to motion in the direction of F₂ and may be expressed as F₂=F₁*e^{μΦ}. That is, F₂ must exceed F₁ by the factor e^{μΦ} for the tensioning cable 310 to move in the direction of F₂.

In the belt tensioning system 300, both the tensioning cable 310 and the capstan 312 are steel, and the value of μ is 0.8. Because the cable 310 wraps two full turns around the roller 312, the value of Φ is approximately 12.6. Thus, for the tensioning cable 310 and the roller 312, the value of e^{μΦ} approximately 23,000 and F₂=F₁*23,000. That is, if F₂ exceeds F₁ by a factor of 23,000, the tensioning cable 310 will move around the capstan 312 in the direction of F₂. However, if F₂ does not exceed F₁ by at least a factor of 23,000, the tensioning cable 310 will not move around the roller 312 in the direction of F₂.

As described for the belt tensioning system 100, in the belt tensioning system 200, the tension T of the belt 102 is typically in a range from T_{low} to Tₙₒₘᵢₙₐₗ. T_{low} typically occurs at startup and typically is established empirically. Tₙₒₘᵢₙₐₗ is the nominal operating tension of the belt 102 and is set by the designer of the system in which the belt 102 is used.

In the belt tensioning system 300, a nominal value for the spring force, F₁, is determined by:

F₁=2*T_{low},

where T_{low} is as described above.

When T is at a low value, the biasing device 314 pulls the tensioning cable 310 counter-clockwise around the rotating one-way clutch roller 312, and the force F₂ applied to the tensioning roller 306 is:

F₂=F₁=2*T_{low}.

In this way, the belt tensioning system 300 operates to prevent T from dropping below a specified minimum level.

However, as T rises above T_{low} (and F₂ rises above 2*T_{low}) and the bracket 308 attempts to pull the cable 310 clockwise around the one-way clutch roller 312, the roller acts as a capstan, preventing the tensioning cable 310 from slipping around the roller 312 in the direction of F₂ unless F₂ rises above F₁ by a factor of 23,000.

Thus, under normal running conditions, as T rises to Tₙₒₘᵢₙₐₗ, the one-way clutch roller 312 resists turning and the force F₂ applied to the tensioning roller 306 is:

F₂=F₁+2*(Tₙₒₘᵢₙₐₗ−T_{low}), or

F₂=2*Tₙₒₘᵢₙₐₗ.

That is, as T varies between T_{low} and Tₙₒₘᵢₙₐₗ, F₂ varies between 2*T_{low} and 2*Tₙₒₘᵢₙₐₗ, because the one-way clutch roller 312 resists turning.

Thus, the tensioning cable 310 may be pulled initially around the rotating one-way clutch roller 312 to adapt to a belt tension near T_{low}. However, once this initial adaptation has occurred, the belt tensioning system 300 remains rigid under the expected dynamic tension loads of the belt 302 within the expected range of range of values for T. Like the belt tensioning system 100, the belt tensioning system 300 has a flexible geometry that may be readily adapted to fir around other components of the belt-driven system. The belt tensioning system 300 also has a smaller footprint, lower cost, and lower maintenance requirements than many other belt tensioning systems. The tensioning roller 312 is mounted to the floating bracket 308, rather than being mounted by a more complex and more expensive articulated mechanism to the base plate 406, as in some other belt tensioning mechanisms.

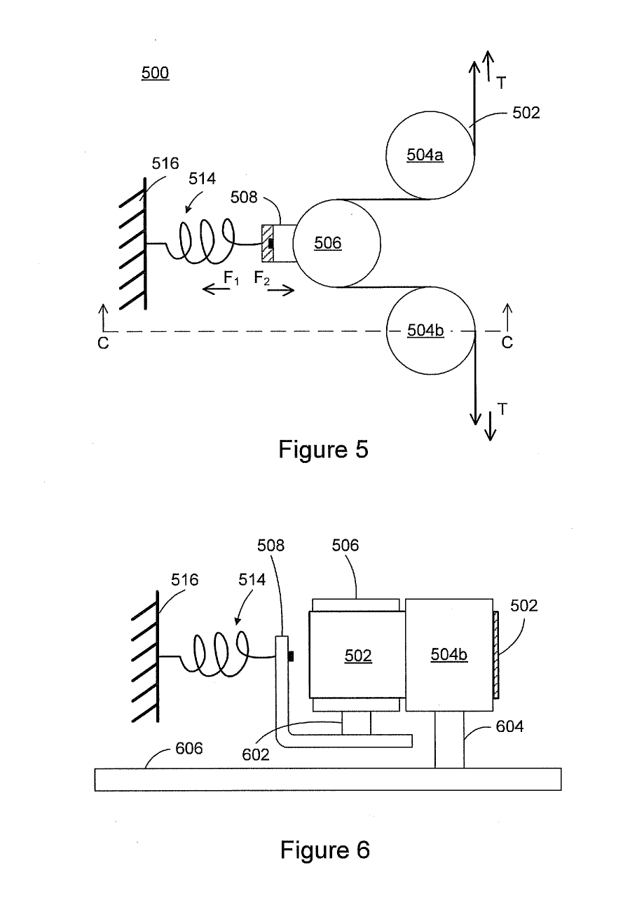

FIG. 5 depicts a top view of a belt tensioning system 500 according to a third embodiment. Unlike the belt tensioning systems 100 and 300, no capstan 112 or one-way clutch roller 312 is used in the belt tensioning system 500. Thus, the belt tensioning system 500 responds to dynamic tensioning loads of the belt being tensioned.

Similar to the belt tensioning system 300, in the belt tensioning system 500 a belt 502 passes over fixed rollers 504a and 504b and around a floating tensioning roller 506. The tensioning roller 506 is typically positioned just before a belt drive roller in the path of the belt 502—for example, fixed roller 504a or 504b, depending upon the direction of travel of the belt 502. The belt 502 extends from the tensioning system 500 into the rest of a larger mechanical system and may be travelling in either direction through the system.

The floating roller 506 is rotatably mounted to a bracket 508, which is used to move the roller 506 to control the tension of the belt 502. As shown in FIG. 5, motion of the roller 506 in a leftward direction increases the tension of the belt 502 and motion in the rightward direction decreases the tension in the belt 502. Unlike in belt tensioning systems 100 and 300, the bracket 508 is mechanically coupled directly to a biasing device 514. In other embodiments, a tensioning cable may be used to mechanically couple the bracket 508 to the biasing device 514. The other end of the biasing device 514 is coupled to a fixed location 516. The biasing device 514 may be an extension spring, a constant force spring, a torsion spring, a suspended dead weight, or other suitable mechanism for applying a force to the tensioning roller 506.

The biasing device 514 applies a force F₁ to the tensioning roller 506, which operates to increase the tension in the belt 502. The bracket 508, acting under the tension of the belt 502, applies an opposing force F₂ to the biasing device 514. When the force F₁ exceeds the force F₂, the bracket 508 and tensioning roller 506 move in a direction to increase the tension in the belt 502 (to the left in FIG. 5). When the force F₂ exceeds the force F₁, the bracket 508 and tensioning roller 506 move in a direction to increase the force applied to the biasing device 514 (to the right in FIG. 5).

FIG. 6 depicts a cutaway view of the belt tensioning system 600 along the line CC of FIG. 5. The one-way clutch roller 512 is mounted to a base plate 606 by a stanchion 608. The tensioning roller 506 is rotatably mounted to the bracket 508 by an axle 602. The fixed roller 504b is rotatably mounted to the base plate 606 by an axle 604. Because the bracket 508 is free to move relative to the base plate 606, the tensioning roller 506 is also free to move relative to the base plate 606, thereby increasing or decreasing tension on the belt 502.

The bracket 508 and the tensioning roller 506 are coupled to the base plate 406 only by the biasing device 514. Where the rollers 502, 504a and 504b are crowned rollers, the belt 502 is constrained from moving in the vertical direction in FIG. 6 and the belt 502 acts as a web element of the structure 500 to support the roller 506 and the bracket 508.

As described for the belt tensioning system 300, in the belt tensioning system 500, the tension T of the belt 502 is typically in a range from T_{low} to Tₙₒₘᵢₙₐₗ. T_{low} typically occurs at startup and typically is established empirically. Tₙₒₘᵢₙₐₗ is the nominal operating tension of the belt 502 and is set by the designer of the system in which the belt 502 is used.

In the belt tensioning system 500, a nominal value for the spring force, F₁, is determined by:

F₁=2*Tₙₒₘᵢₙₐₗ,

where Tₙₒₘᵢₙₐₗ is as described above. When T begins to fall below Tₙₒₘᵢₙₐₗ, the tensioning roller 506 moves to the left to keep the belt tension at Tₙₒₘᵢₙₐₗ. Similarly, when T begins to rise above Tₙₒₘᵢₙₐₗ, the tensioning roller 506 moves to the right to keep the belt tension at Tₙₒₘᵢₙₐₗ.

As such, the belt tensioning system 500 does not remain rigid under the dynamic tension loads of the belt 502. However, like the belt tensioning system 300, the belt tensioning system 500 has a flexible geometry that may be readily adapted to fir around other components of the belt-driven system. The belt tensioning system 500 also has a smaller footprint, lower cost, and lower maintenance requirements than many other belt tensioning systems. Also, the tensioning roller 512 is mounted to the floating bracket 508, rather than being mounted by a more complex and more expensive articulated mechanism to the base plate 606, as in some other belt tensioning mechanisms.

In some circumstances, a roller (for example, roller 504a) must be removed from a belt system utilizing a belt tensioning system according to this disclosure. Such circumstances might arise where an item being transported by the belt system becomes jammed and tension in the belt system must be temporarily reduced below T_{low} in order to remove the jammed item. In such circumstances, the belt tensioning systems 100 and 300 will operate to pull the tensioning rollers 106 and 306, respectively, to increase tension in the belt to their respective minimum tensions. When the roller is replaced in the belt system, however, the capstan effect of the capstan 112 and the one-way clutch roller 312 will operate to prevent motion of the tensioning rollers 106 and 306, respectively, resulting in higher than expected tension in the belts 102 and 302. In belt systems where the need to remove a roller does not arise, or where operation of the belt tensioning system may be disabled while the roller is removed, the belt tensioning systems 100 and 300 provide the dual benefits of the ability to remain rigid under the expected dynamic tensioning loads of the belt being tensioned, as well as the reduced cost and mechanical simplicity of the floating tensioning roller. In belt systems where the need to remove a roller does arise and operation of the belt tensioning system cannot be disabled while the roller is removed, the belt tensioning system 500 provides the benefit of reduced cost and mechanical simplicity of the floating tensioning roller.

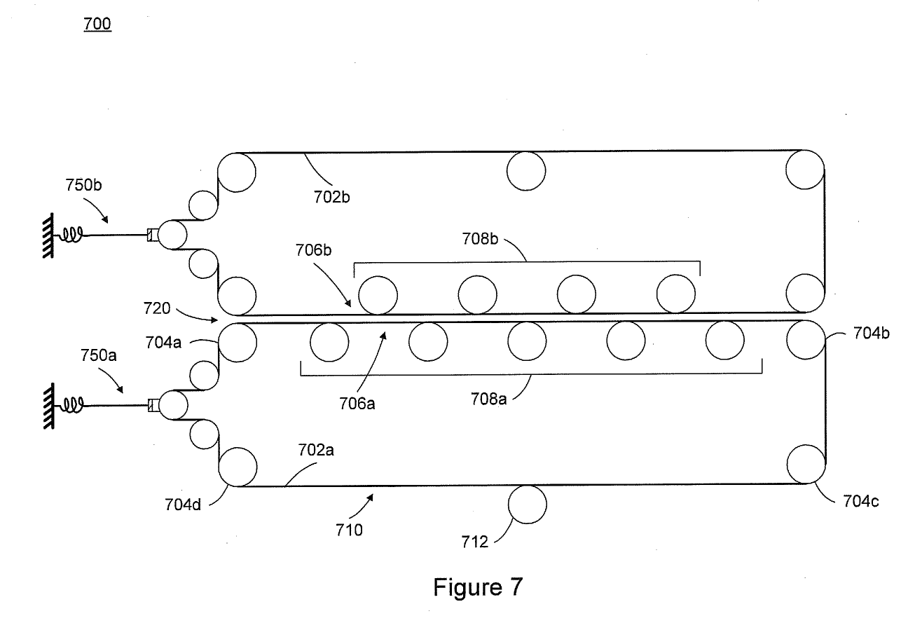

FIG. 7 depicts a top view of a conveyor belt system 700 according to an embodiment. The conveyor belt system 700 includes conveyor belts 702a and 702b and associated belt tensioning systems 750a and 750b. In FIG. 7, the belt tensioning systems 750a and 750b are similar to the belt tensioning system 500 of FIGS. 5 and 6, however, it will be understood that the belt tensioning system 100 of FIGS. 1 and 2, the belt tensioning system 300 of FIGS. 3 and 4, or any other belt tensioning system according to this disclosure may be used in the conveyor belt system 700.

The conveyor belt 702a moves in a clockwise direction, driven by a drive roller 704a. The conveyor belt 702 passes, in turn, around idler rollers 704b, 704c, and 704d. The conveyor belt 702a includes a working section 706a, which is constrained by idler rollers 708. A return section 710 of the conveyor belt 702a is constrained by a single idler roller 712. The conveyor belt 702b moves in a counter-clockwise direction, but is otherwise similar to the belt 702a, being driven by a drive roller, having a working section 706b, passing around idler rollers, and being constrained by idler rollers 708b.

The conveyor belt system 700 is configured as a pinch drive system. That is, the working sections 706a and 706b are located adjacent to each other to form a gap 720, into which items may be introduced, to be “pinched” between the belts 702a and 702b and transported from the left end to the right of the conveyor belt system 700, as shown in FIG. 7. Such items may be envelopes or flats, which are held vertically between the belts 702a and 702b while being transported past operators or automated address reading machines for the purpose of sorting in a postal mail handling system.

While the belt tensioning systems 550a and 550b are used in the pinch drive conveyor belt system 700, it will be understood that belt tensioning systems according to the disclosure may be used in any suitable belt system, including horizontal conveyor belts, power drive belts, manufacturing applications, food handling applications, and other moving belt systems.

Those skilled in the art will recognize that, for simplicity and clarity, the full structure and operation of all systems suitable for use with the present disclosure is not being depicted or described herein. Instead, only so much of the physical systems as is unique to the present disclosure or necessary for an understanding of the present disclosure is depicted and described. The remainder of the construction and operation of the systems disclosed herein may conform to any of the various current implementations and practices known in the art.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A belt tensioning apparatus, comprising:
a fixed roller, rotatably coupled to a structure;
a tensioning roller, rotatably coupled to a bracket; and
a biasing device coupled to the structure and to the bracket,
wherein the bracket and the tensioning roller are coupled to the structure only by the biasing device and a belt, the belt passing around at least a part of the fixed roller and at least a part of the tensioning roller.

2. The belt tensioning apparatus of claim 1, wherein the biasing device comprises one of an extension spring, a constant force spring, a torsion spring, and a suspended dead weight.

3. The belt tensioning apparatus of claim 1, further comprising:
a capstan; and
a tensioning cable coupling the biasing device and the bracket, the tensioning device coupled at a first end to the bracket and at a second end to the biasing device,
wherein
a portion of the tensioning cable is in contact with a surface of the capstan,
the biasing device is configured, when tension in a belt passing around at least a part of the fixed roller and at least a part of the tensioning roller is at or below a first level, to pull the tensioning cable around the capstan to raise the tension in the belt to a specified minimum level, and
the tensioning cable and capstan are configured to prevent the tensioning cable from slipping along the surface of the capstan in the direction of the bracket when the tension in the belt is between the first level and a second level, where the second level is higher than the first level.

4. The belt tensioning apparatus of claim 3, wherein the biasing device is configured to apply a force to the tensioning cable, the force determined as a function of an expected operating tension of the belt, a capstan effect factor, and a constant amount.

5. The belt tensioning apparatus of claim 3, wherein the tensioning cable comprises steel and the surface of the capstan comprises steel.

6. The belt tensioning apparatus of claim 3, wherein the capstan comprises a one-way clutch mechanism, the one-way clutch mechanism configured to allow the capstan to rotate when the tensioning cable moves in the direction of the biasing mechanism and to prevent the capstan from rotating when the tensioning cable moves in the direction of the bracket.

7. The belt tensioning apparatus of claim 6, wherein the biasing device is configured to apply a force to the tensioning cable, the force determined as a function of the first level of tension of the belt.

8. A moving belt system comprising:
a belt; and
a belt tensioning apparatus, comprising:
a fixed roller, rotatably coupled to a structure;
a tensioning roller, rotatably coupled to a bracket; and
a biasing device coupled to the structure and to the tensioning roller,
wherein
the belt passes around at least a part of a fixed roller and at least a part of a tensioning roller, and
the bracket and the tensioning roller are coupled to the structure only by the tensioning cable and the belt.

9. The moving belt system of claim 8, wherein the biasing device comprises one of an extension spring, a constant force spring, a torsion spring, and a suspended dead weight.

10. The moving belt system of claim 8, wherein the belt tensioning system further comprises:
a capstan; and
a tensioning cable coupling the biasing device and the bracket, the tensioning device coupled at a first end to the bracket and at a second end to the biasing device,
wherein
a portion of the tensioning cable is in contact with a surface of the capstan,
the biasing device is configured, when tension in the belt is at or below a first level, to pull the tensioning cable around the capstan to raise the tension in the belt to a specified minimum level, and
the tensioning cable and capstan are configured to prevent the tensioning cable from slipping along the surface of the capstan in the direction of the bracket when the tension in the belt is between the first level and a second level, where the second level is higher than the first level.

11. The moving belt system of claim 10, wherein the biasing device is configured to apply a force to the tensioning cable, the force determined as a function of an expected operating tension of the belt, a capstan effect factor, and a constant amount.

12. The moving belt system of claim 10, wherein the tensioning cable comprises steel and the surface of the capstan comprises steel.

13. The moving belt system of claim 10, wherein the capstan comprises a one-way clutch mechanism, the one-way clutch mechanism configured to allow the capstan to rotate when the tensioning cable moves in the direction of the biasing mechanism and to prevent the capstan from rotating when the tensioning cable moves in the direction of the bracket.

14. The moving belt system of claim 13, wherein the biasing device is configured to apply a force to the tensioning cable, the force determined as a function of the first level of tension of the belt.

15. A method for tensioning a belt, the belt passing around at least a part of a fixed roller rotatably coupled to a structure and at least a part of a tensioning roller rotatably coupled to a bracket, the method comprising:
providing a biasing device coupled to the structure; and
coupling the biasing device to the bracket,
wherein the bracket and the tensioning roller are coupled to the structure only by the biasing device and the belt.

16. The method of claim 15, wherein the biasing device comprises one of an extension spring, a constant force spring, a torsion spring, and a suspended dead weight.

17. The method of claim 15, wherein coupling the biasing device to the bracket comprises coupling a first end of a tensioning cable to the biasing device and coupling a second end of the tensioning cable to the bracket, the method further comprising:
positioning a portion of the tensioning cable in contact with a surface of a capstan, where the tensioning cable is coupled at a first end to the bracket and at a second end to the biasing device,
configuring the biasing device to pull the tensioning cable around the capstan, when tension in the belt is at or below a first level, to raise the tension in the belt to a specified minimum level; and
configuring the tensioning cable and capstan to prevent the tensioning cable from slipping along the surface of the capstan in the direction of the bracket when the tension in the belt is between the first level and a second level, where the second level is higher than the first level.

18. The method of claim 17, further comprising configuring the biasing device to apply a force to the tensioning cable, the force determined as a function of an expected operating tension of the belt, a capstan effect factor, and a constant amount.

19. The method of claim 17, wherein the capstan comprises a one-way clutch mechanism, the one-way clutch mechanism configured to allow the capstan to rotate when the tensioning cable moves in the direction of the biasing mechanism and to prevent the capstan from rotating when the tensioning cable moves in the direction of the bracket.

20. The method of claim 19, wherein the biasing device is configured to apply a force to the tensioning cable, the force determined as a function of the first level of tension of the belt.
